(19) United States
(12) Patent Application Publication
(10) Pub. No.: US 2015/0019279 A1
(43) Pub. Date: Jan. 15, 2015

(54) FILLING INSTALLATION AND COMPUTER-IMPLEMENTED METHOD FOR THE AUTOMATIC ESTABLISHMENT OF A CURRENT AND INDIVIDUAL WORK LIST

(71) Applicant: KRONES AG, Neutraubling (DE)

(72) Inventors: Thomas Kellhammer, Neutraubling (DE); Wolfgang Hahn, Neutraubling (DE)

(21) Appl. No.: 14/377,562

(22) PCT Filed: Dec. 3, 2012
(86) PCT No.: PCT/EP2012/074219

§ 371 Date: Aug. 8, 2014

(30) Foreign Application Priority Data
Feb. 14, 2012 (DE) 10 2012 202 217.1

(51) Int. Cl. G06Q 10/06; B67C 3/00; G06Q 50/04

(52) U.S. Cl. CPC G06Q 10/063116; G06Q 50/04; B67C 3/007
USPC 705/7.16

(57) ABSTRACT

A filling installation having at least one component, where for each component first data relating to a planned operation are available, and each component generates second data relating to malfunctioning, each component designed to make available the first and second data at a data interface, the data interface designed to transmit the first and second data to a data collector and/or to receive queries of the data collector and, in response to a query, to transmit the first and second data to the data collector. The data collector is designed to receive and/or to query the first and the second data of the at least one component and to establish at least one work list based thereon, and having at least one mobile information unit that is designed to represent a work list. Also, a computer-implemented method for the automatic establishment of a work list.

### CROSS-REFERENCE TO RELATED APPLICATION

The present application is the United States national phase of International Patent Application No. PCT/EP2012/074219, filed Dec. 3, 2012, which application claims to German Application No. 10 2012 202 217.1, filed Feb. 14, 2012. The priority application is hereby incorporated by reference.

### FIELD OF THE DISCLOSURE

The present disclosure relates to a filling installation and a computer-implemented method for the automatic establishment of a current and individual work list with at least one task to be performed for a person.

### BACKGROUND

The staff in an industrial plant is mostly preoccupied with reacting to specific situations; if several persons are present who are in charge of different and/or identical task areas, an arrangement is needed as to who has to perform which task(s) until when.

In a filling installation of the beverage industry, for instance, the persons who are operating one or several interlinked machines have to feed these machines at certain time intervals, which depend e.g. on the throughput, with consumable materials, for instance with preforms, caps, labels and/or packaging material, etc. In addition to such supply tasks, malfunctions may occur on one or several machines; these are e.g. caused by material tolerances or manufacturing errors. Such a malfunction on a machine may necessitate the intervention of a person who is also operating that machine during normal operation, or of a person who does not operate said machine during normal operation and is only assigned to it for eliminating the malfunction.

Such a malfunction may e.g. occur when a preform gets jammed in the inlet of a stretch blow molder due to a plastic burr in the preform chute. The malfunction can very rapidly be eliminated by the person himself, but the person must first recognize the malfunction and/or must be informed about it. The person should react to and eliminate the malfunction as fast as possible, so that the interlinked machines are not interrupted while running, i.e. during normal operation, by the malfunctioning. It may happen that the person might thus have to interrupt an already started task in order to eliminate the malfunction first before completing this task.

Such malfunctions cannot be planned in advance, but have an influence on the sequence of tasks to be performed to maintain an operation of the installation. The tasks concerning a material supply are often non-critical in terms of time and/or they may have a certain time buffer during which they have to be performed.

To eliminate a malfunction, it may be necessary that a malfunction on a first machine, e.g. a packaging machine, which is operated by a first person, can only be eliminated quickly if the first person is assisted by a second person who is operating the stretch blow molder during normal operation. It becomes apparent from these examples that although the responsibilities of the individual persons are defined (during normal operation of the installation), the sequence of the execution of tasks may change and/or tasks can be assigned to persons who are not responsible for these tasks during normal operation if e.g. one or several malfunctions occur.

A work list which comprises plannable tasks, i.e., for instance the supply with consumable materials during normal operation of the installation, can thus be established for every person in advance according to arrangements as to who has to perform which task(s) until when, i.e. before execution of the tasks, e.g. at the beginning of a work day. Such a work list, however, is not very flexible in the case of unexpected events which occur due to further and/or redistributed jobs and/or malfunctions and which are to be incorporated into an already existing work list. A renewed arrangement must be made so that a person is e.g. informed about new tasks which said person is to perform. Thus, it may happen that the working time of a person is inefficiently used because idle times are contained, whereas with another person bottlenecks may occur because a malfunction occurs in said person's work area, which malfunction must be eliminated by said person in addition to the tasks of the previously established work list.

The work lists are also not very flexible in the case of an unplanned absence of a person whose tasks have thus to be taken over by other persons.

U.S. Pat. No. 5,216,593 discloses a method and an apparatus for reducing the computational effort in the areas of production planning and logistics, scheduling, distribution and resource allocation. Moreover, a means is provided that collects and evaluates inventory and order data, draws up and evaluates a production plan and monitors the execution of this plan.

A so-called Discrete Activity Resource Allocation (DARA) problem is here solved, where all activities and resources that do not contribute to profit maximization are first of all reduced. A model is formulated and, based on this model, a “clique and cover” list is made that defines boundary conditions. The linear relaxation of the DARA problem is solved, and the inequalities induced by the “clique and cover” list are checked to select a set of activities violated by the solution of the linear relaxation of the DARA problem. Decisions are indicated to update the data, and the calculation is repeated until there are no longer any inequalities. The solution then yields an optimal resource allocation producing the maximum profit.

DE 101 18 504 A1 discloses a method and an apparatus for the predictive correction of regulation or control value deviations to be paid attention to in the processing of alternating-current or voltage values, by way of a predictive adaptation of the reference parameters underlying the current and voltage regulation. This predictive adaptation is carried out by additional implementation of control elements, which are conditioned depending on the transfer function of the regulating circuit or the system equations, within the existing control scheme for current or voltage regulation, whereby a compensation or regulation of the regulation or control value deviations possibly occurring during the processing of alternating-current or voltage parameters can already be taken into account in advance.

DE 101 25 504 A1 discloses a method and a computer system for workflow management for the management of work processes regarding a patient or regarding the examination proper, for the provision of digital image data at desired places and for monitoring the processing at the diagnosis workplaces by means of lists. Thus, the distribution of tasks among different processing persons or groups of processing persons and their corresponding workplaces as well as the configuration of the individual workplaces and the provision of data become possible.

DE 10 2004 031 249 A1 discloses the controlling of a rotting process of substance mixtures with organic amounts with the help of a process model which includes a predictive optimization of the setting of the control values based on a process prognosis. The process prognosis can be derived from process history and boundary conditions based on the model. To define an optimal control condition, process prognoses are made by calculating different scenarios by way of the process model.

EP 0 987 322 A1 discloses the determination of actuating variables for regulating an optimum wort outflow in a self-learning manner, wherein a model of a real lauter process is used, including the actuating devices. The model is formulated in the form of differential equations in relation to equidistant scanning times and describes the static and dynamic correlations between the measurable starting variables and the process correcting variables in consideration of further measured variables of the lauter process. With the help of the model, it is possible to calculate in advance the influence of current and future actuating variables on the further behavior of the starting variables of the lauter process.

DE 100 50 224 A1 discloses a method and a device for monitoring and/or controlling moving objects provided with a mobile unit which can transmit position and object data to a control unit by radio, wherein the mobile unit can be controlled by the control unit, which is configured as a regulation unit, by transmission of control commands.

DE 102 50 162 A1 discloses that dispatch data of a transport order can be stored online via an internet page in a database, the database being connected to a navigation computer. Transport data of a hauler are entered via the internet page in the navigation computer which will then select a route from the orders stored in the database. If a selected order is accepted by the hauler, the dispatcher is informed. The navigation computer can compute a route with optimum utilization of the truck by paying attention to marginal parameters, such as legal rest times of the driver, maximum payload, or the like.

DE 10 2006 004 400 A1 discloses a navigation system which has a matrix-like network of placemarks which indicate a spatial position. The place information of radio transponders on the placemarks can be read out when a robot is running with a navigation unit mounted thereon over the radio transponder; the orientation of the robot can here be determined by way of a compass. Hence, directional information is provided as soon as the robot has traveled over only one single placemark.

DE 10 2008 048 552 A1 discloses a method in an industrial system in which state data of components, machines and lines are transmitted, and wherein the state data can be represented by means of at least one user unit. This permits a locally independent access to the access data of all components, machines and lines of the system. The access data can be assigned to specific topics and grouped accordingly. With the help of the user unit, lines, components and machines can also be controlled. It may be provided that specific error messages of the system only reach defined users to whom the error message is of relevance. Moreover, the representation of the access data and also of input data in relation to the spatial position of user unit relative to line, component and/or machine can be restricted.

DE 10 2010 013 794 A1 discloses a mobile measuring and calibrating unit which enables a person on site to calibrate a machine, wherein the measurements carried out by the person or the resulting deviations of a currently determined operational state from a standard state of the machine are determined and documented. If a deviation exceeds a threshold value, the machine can be switched off automatically or its performance can be adapted. It may also be provided that suitable elimination routines are displayed; these make it possible to eliminate the causes responsible for the deviation.

DE 10 2010 013 884 A1 discloses a control and organization unit which upon occurrence of a fault associated with a machine informs a person who is to be determined according to predefined selection criteria and is present in the vicinity of the machine. If several persons are needed, their cooperation can be coordinated.

DE 10 2010 013 885 A1 discloses a maintenance unit which by recognizing, identifying and displaying a current operating state of a machine can accompany, log and control a diagnosis and/or repair on the machine in relation to a normal state of the machine one step at a time; this can be adapted to a person operating the maintenance unit.

The Deutsche Forschungszentrum für Künstliche Intelligenz [German Research Center for Artificial Intelligence] in D-67663 Kaiserslautern is inter alia concerned with innovative factory systems (IFS). In the SmartFactory™, a message can be sent, for instance per SMS or GPRS, in case of an unforeseen event to a person in charge. This person can be informed about the type of incident and about the technician who is qualified and available for performing repair work. In the factory an installation plan can be displayed to the technician on a wristband including a personal computer, so that the technician can find the component to be repaired. It is possible to diagnose, maintain and parameterize system components on site by way of a radio-communications infrastructure.

### SUMMARY OF THE DISCLOSURE

It is one aspect of the present disclosure to provide a filling installation and a method permitting an efficient and reliable operation of an industrial plant. This is achieved in that a person receives information on forthcoming tasks, on the place where the task is executed and/or on the currently useful sequence of the tasks to be executed, independently of the person's whereabouts. The tasks may include a supply with consumable materials and/or an elimination of malfunctions, or the like.

A filling installation comprises at least one component, wherein for each component first data relating to a planned operation of the filling installation are available, and wherein each component generates second data relating to malfunctioning of the filling installation. The first data can be generated by a person, for instance a user of the filling installation, and transmitted by using a data interface to the component. The component can be equipped for reception of the first data with a data processing program. The second data can be generated by means of the same or by means of a different data processing program. Each component is designed to make available the first and the second data at a data interface of the component. The data interface is designed to transmit the first and the second data to a data collector of the filling installation and/or to receive queries of the data collector and, in response to a query, to transmit the first and the second data to the data collector. The data collector is designed to receive and/or to query the first and the second data of the at least one component, wherein the data collector is further designed to establish at least one current and individual work list based on the first and the second data. Moreover, the filling installation comprises at least one mobile information unit, wherein each information unit is designed to represent one of the at least one work list.

A component of the filling installation may here be a filling, labeling or packaging machine. For a planned operation of the filling installation these components are operating with predefined operational parameters. To be able to maintain said operational parameters, predefined tasks have to be executed, such as for instance further supply of caps, labels and/or film. For such tasks each component generates first data, wherein said first data for each predefined task comprise data on a task area, such as operation, quality control or maintenance, temporal start and temporal duration of the at least one task.

The second data may comprise information on malfunctioning, such as e.g. a falling short of a minimum number of existing labels in a labeling machine, blockage by a bottle or failure of a machine component, such as a motor. If not eliminated, such malfunctions may lead to a deviation from the planned operation of the filling installation. A malfunction may also be the complete absence of labels in a labeling machine. A higher priority could then be assigned to this malfunction than to the malfunction displaying a falling short of a minimum number of existing labels in a labeling machine. In a work list the task area “malfunction” could be assigned to a malfunction, so that it is clearly discernible that this is not a predefined task, but an (unplanned) malfunction.

The first and the second data of each of the at least one component are then made available to a data interface so that they can be transmitted to or queried from a data collector. The data collector is designed such that it can establish at least one current and individual work list based on the first and the second data. To this end the data collector can comprise an execution program which is e.g. stored in a storage medium and comprises instructions to establish at least one current and individual work list from the first and the second data.

The data collector can further be designed to receive and/or to query personal data. The personal data may be data on at least one work area in which the person is working, such as operation, quality control, maintenance and/or malfunction, temporal beginning and temporal end of working times. When work lists are made, special tasks which are to be executed on different components can thus be assigned to one person and other tasks to another person.

The at least one component can further be designed to pre-process the first and the second data. For instance, tasks which are comprised by the first data, and malfunctions which are comprised by the second data can be sorted according to their priority, so that upon establishment of a work list, malfunctions and/or tasks with a high priority can be attended to earlier than malfunctions and/or tasks with a lower priority.

The at least one mobile information unit can further be designed to transmit third data to the data collector. For instance, a user of the mobile information unit can make an entry that he is not available for a task and/or malfunction in the work list. This information can be transmitted to the data collector, so that this task and/or malfunction are incorporated into another work list, whereby the task can be executed by another user and/or the malfunction can be eliminated.

A computer-implemented method for the automatic establishment of a current and individual work list with at least one task to be performed for a person, wherein the work list can be transmitted to a mobile information unit and is intended for use in an industrial plant, for instance in a filling installation, by the person comprises the following steps: personal data of at least one person are read in, wherein the personal data for each of the at least one person comprise data on at least one work area, such as operation, quality control, maintenance and/or malfunction, temporal beginning and temporal end of working times.

The personal data can be stored on a storage medium, but they can also be generated and/or entered on a computer on which the computer-implemented method is to be carried out. The personal data contain information permitting an assignment of tasks to be performed to a person. The persons may be active in different work areas, so that only tasks falling within their work area should be assigned to them. A person who is e.g. only active in the work area operation should not have assigned to him any tasks from the area quality control as this person cannot or must not perform this task in general. A further criterion for the assignment of tasks to be performed is the temporal availability of a person, i.e., the person must be present at the time of the task and should not have to execute other tasks at that time. A task to be performed can be defined by a start time and by the duration of the task. The duration of the task may here be a predefined value that follows from empirical values, e.g. from the duration needed by tasks performed in the past.

To have available data relating to the tasks, task data are read in from a first data set and from a second data set, wherein task data of at least one task are read in, wherein the task data for each of the at least one task comprise data relating to a task area, such as operation, quality control, maintenance or malfunction, temporal start and temporal duration of the at least one task. In case of a malfunction the temporal start would e.g. conform to the time at which the malfunction has occurred. An empirical value can be indicated as temporal duration; this value has followed from the duration of time during which a corresponding, previously occurring malfunction lasted until complete elimination so that no malfunction existed any more. It can e.g. be determined through the details relating to the task area whether a task area corresponds to a work area of a person, i.e., when a task is to be carried out in the task area “maintenance”, this task can be assigned to a person who is active in the work area “maintenance” if said person is temporally available.

The first data set can comprise the above-mentioned first data which refer to a planned operation of the installation. The second data set can comprise the above-mentioned second data which comprise information on malfunctioning. Hence, it is possible to consider tasks which are planned in the work lists, and unplanned tasks (malfunctions), and to assign them for instance to one or more persons who will then perform said tasks.

To be able to establish an individual work list for each person, the individual tasks are assigned one after the other to the different persons who can be detected in the personal data, according to the work/task area and the temporal availability.

To this end in a step a) it is determined for a first one of the at least one task whether the task area of the first task corresponds to the at least one work area of a first one of the at least one person. If this is the case (“if yes”), it is determined in a step b) whether a temporal start and a temporal duration of the first task are within a range between a temporal beginning and a temporal end of a working time of the first person. It can thereby be determined whether the first person is temporally available for the first task. If this is the case (“if yes”), the first task is added to a first work list of the first person in a step c). This first work list can here be regarded as an individual work list for the first person.

Since the first task has now been assigned to the first person, the first task is irrelevant for further assignments and the first task is therefore removed from the task data in a step d). Hence, updated task data can be established.

An updating of the personal data also makes sense because the temporal availability of a person changes due to the assignment of a task as this person is not available for other tasks at the time of the assigned task. In a step e) a temporal availability of the first person is updated in the personal data of the first person, so that no further task can be assigned to the first person for a period defined by the temporal beginning and the temporal duration of the first task.

In a step f) if at least one other task is present in the task data, one returns to step a), wherein it is determined whether for another one of the at least one task the task area of this other task corresponds to the at least one work area of the first person.

Hence, all tasks that are present in the task data can be executed. An assignment of all tasks to persons can here not necessarily be guaranteed as this may be prevented by non-matching work/task areas or non-matching temporal availability, respectively. In such a case it is necessary, as described further below, to request a new person who can cover a corresponding task area through his work area and is temporally available, or to change operational parameters of the industrial plant, so that the temporal start of a task can be changed and this task can then be executed by one of the persons.

If it is determined in step b) that the temporal start and the temporal duration of the first task are not within a range between a temporal beginning and a temporal end of a working time of the first person (“if no”), one returns in a step g) to step a), wherein it is determined whether the task area of the first task corresponds to the at least one work area of another one of the at least one person, and the steps of the method are performed for the other person. Hence, it can be checked whether the task can be assigned to another person who is recognizable from the personal data.

If in a step a) one determines for a first one of the at least one task that the task area of the first task does not correspond to the at least one work area of the first one of the at least one person (“if no”), one returns in a step h) to step a), wherein it is determined whether the task area of the first task corresponds to the at least one work area of another one of the at least one person, and the steps of the method are performed for the other person.

If in the attempt to assign a task, as is apparent from the task data, to the persons who are recognizable from the personal data, all persons have already been checked in the method steps without the task being assignable, which means that there is no further person present whom the task can be assigned to, the computer-implemented method can comprise the following steps instead of step h) if there is no other person: a new person can be requested whose at least one work area corresponds to the first task area. The first task can then be added to a work list of the new person, and the first task can be removed from the task data. Moreover, a temporal availability of the new person can be updated in the personal data of the new person, so that no further task can be assigned to the new person for a period defined by the temporal beginning and the temporal duration of the first task.

It may be necessary to request a new person so as to be able to assign, nevertheless, tasks that could not be assigned to persons who are recognizable from the personal data as there is no correspondence between work area and task area, so that the task can be executed by the new person. Since one knows the task area of the task, one can preferably request a new person who is active in a work area corresponding to the task area. This new person may be a person who is e.g. ready to take over tasks.

If one determines that the temporal start and the temporal duration of the first task is not within a range between the temporal beginning and the temporal end of a working time of one of the at least one person, the computer-implemented method can comprise the following steps instead of step g) if no other person is present: requesting a new person whose at least one work area corresponds to the first task area. The first task can then be added to a work list of the new person, and the first task can be removed from the task data. Moreover, a temporal availability of the new person can be updated in the personal data of the new person, so that no further task can be assigned to the new person for a period defined by the temporal beginning and the temporal duration of the first task.

Hence, a new person can be requested to take over a task if it becomes evident—in the attempt to assign a task, which is apparent from the task data, to the persons who are recognizable from the personal data—that none of these persons is temporally available to take over said task.

The computer-implemented method can further comprise the step that boundary conditions are read in, wherein the boundary conditions comprise for instance operational parameters of an industrial plant and predefined, permitted changes in the operational parameters.

Hence, when one determines that the temporal start and the temporal duration of the first task are not in a range between the temporal beginning and the temporal end of a working time of one of the at least one person, it is possible that the computer-implemented method further comprises the following steps: determining a new start time of the task based on the predefined, permitted changes in the operational parameters, and determining whether for the new start time of the task the task area corresponds to the at least one work area of one of the at least one person and whether said person is temporally available, by determining whether the new start time and the temporal duration of the task are within a range between a temporal beginning and a temporal end of a working time of the person. The determination of a new start time of the task may e.g. be of the type that a reduction of the speed of a transport belt of filled containers in relation to a labeling machine is possible by up to 10% as a predefined, permitted change. When the speed is reduced by 10%, fewer bottles will reach the labeling machine within a time unit, so that fewer labels are consumed and a refilling of labels can be postponed to a later time.

If this is the case (“if yes”), the task can be added to a work list of the person, and a temporal availability of the person can be updated.

Since the task has now been assigned to the person, this task is irrelevant for further assignments and can therefore be removed from the task data. Hence, updated task data can be generated.

If this is not the case (“if no”), i.e. when the new start time of a task does not allow the assignment of the task and when the read-in personal data do not comprise a person who has time for the task, a new person can be requested whose at least one work area corresponds to the task area. The task can be added to a work list of the new person, and a temporal availability of the new person can be updated in the personal data of the new person, so that no further task can be assigned to the new person for a period defined by the temporal beginning and the temporal duration of the first task. Since the task has now been assigned to the person, this task is irrelevant for further assignments and can therefore be removed from the task data. Thus updated task data can be generated.

Furthermore, the computer-implemented method comprises the step of transmitting the work list of the at least one person to a mobile information unit of the at least one person. Hence, based on his mobile information unit, the person can take note of the tasks he is to perform if he is inside the industrial plant.

Preferably, the work list of the at least one person can be represented by means of a representation device of the mobile information unit for this purpose. It may be provided that the whole work list is displayed or also only the task to be performed next in time, or the one, two, three or more tasks to be performed next in time. As for the individual tasks, information on a beginning of the task, task area, place of the task and/or duration of the task can be represented and/or queried by the person. Other information on the individual tasks can also be represented and/or queried by the person.

To enable the person to easily and quickly find the place where a task is to be performed, a route which the at least one person is preferably to choose in order to arrive at the place where a component of the industrial plant is located and where a task is to be performed or a malfunction is to be eliminated can be graphically represented, wherein the graphic representation can be performed by means of the representation device of the mobile information unit. The indication of a route makes especially sense if a widespread industrial plant is concerned that is possibly erected on different levels and/or when the person does not exactly know the layout of the industrial plant. Thus, the selection of a wrong or long route by the person can be avoided.

Moreover, in combination with the route or also independently of the representation of the route, a current location of the at least one person and a/the place where a task is to be performed can be graphically represented, wherein the graphic representation can be performed by means of the representation device of the mobile information unit.

The graphic representation may be in a two-dimensional and/or three-dimensional way, so that e.g. different levels of the industrial plant and/or obstacles to be overcome along the way between the current location of the person and the place where a task is to be performed can be represented.

A work list can here be established together with representations of route and/or place, and the person can manually switch back and forth between the individual representations or the alternating representation may be automatic, for instance at a predefined frequency.

Moreover, the computer-implemented method can read in new personal data of at least one person, wherein the new personal data for each of the at least one person comprise data on at least one work area, such as operation, quality control, maintenance and/or malfunction, temporal beginning and temporal end of working times. The reading in of new personal data may be required if further persons are to take over tasks to be performed and/or if due to illness of persons who were contained in previous personal data are not available for the taking over of tasks. Hence, it can be guaranteed that the personal data and thus the work lists established are up to date.

Moreover, new task data of at least one task can be read in, wherein the new task data for each of the at least one task comprise data on a task area, such as operation, quality control, maintenance or malfunction, temporal beginning and temporal duration of the at least one task. Hence, further tasks that are to be distributed and/or the temporal start of which has changed can be taken into consideration in the establishment of work lists. This is particularly advantageous when malfunctions occur in the industrial plant that should in general be eliminated as soon as possible so that such a malfunction will not lead to a system stop and/or damage to a component of the system.

### BRIEF DESCRIPTION OF THE DRAWINGS

Further advantages, features and details of the disclosure become apparent from the following description of preferred embodiments and from the drawings, in which:

FIG. 1 shows a flow diagram of a method for the establishment of work lists;

FIG. 1A shows a flow diagram with details for the establishment process of the work lists;

FIG. 1B shows a process for requesting a further person of a specific task area;

FIG. 1C shows a process for requesting a further person for taking over a task or for changing start times for tasks to be performed by paying attention to boundary conditions;

FIG. 2A shows a work list of a first person;

FIG. 2B shows a work list of a second person;

FIG. 3A shows the updated work list of the first person of FIG. 2A;

FIG. 3B shows the updated work list of the second person of FIG. 2B; and

FIG. 4 shows a filling installation with plural components which generate data that can be processed by means of a data collector into work lists and transmitted to mobile information units.

### DETAILED DESCRIPTION

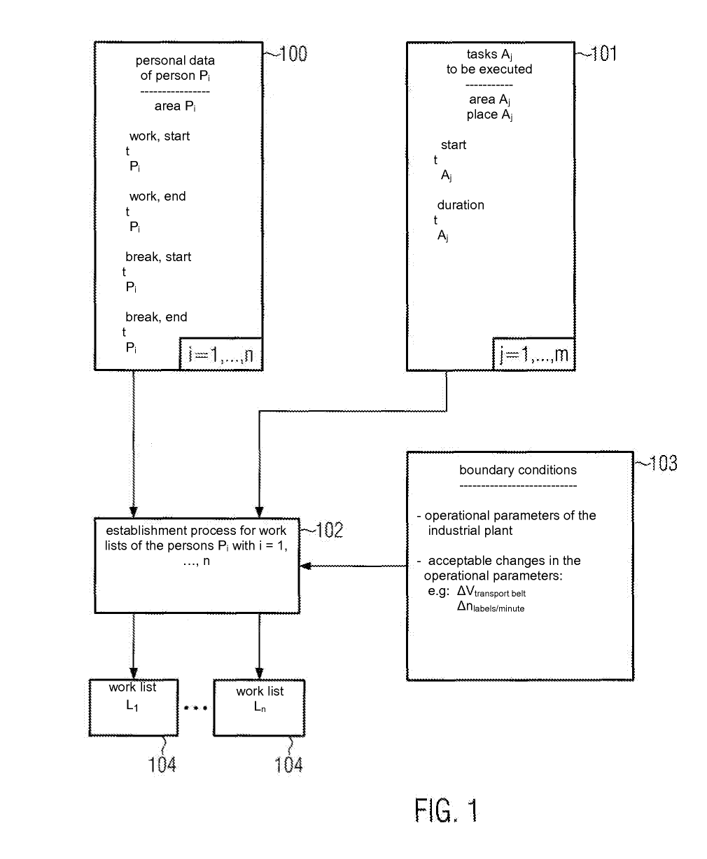

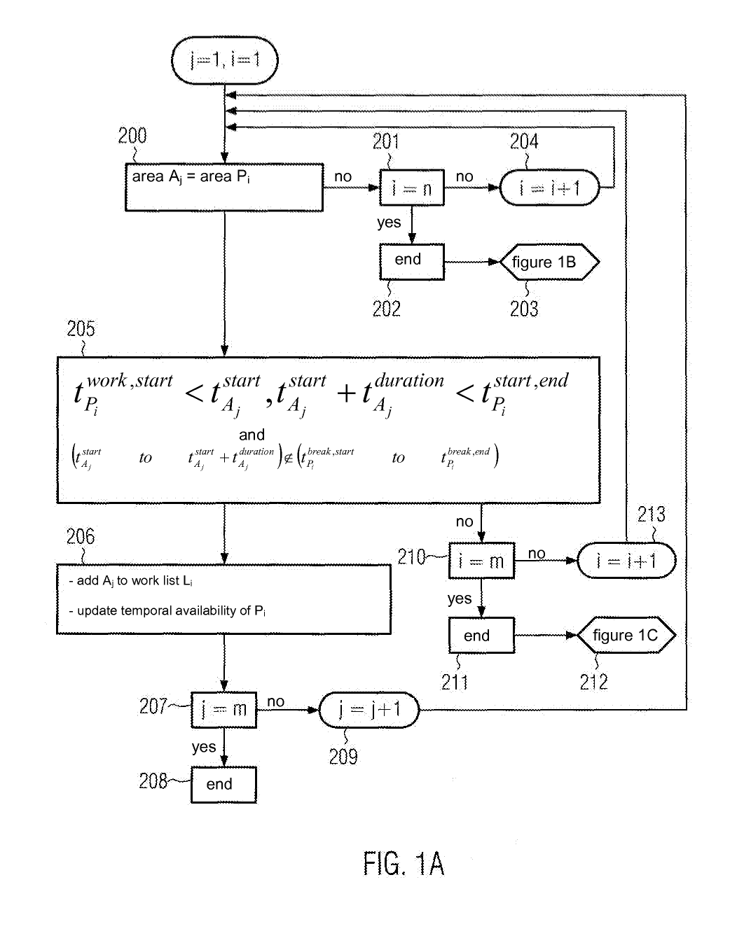

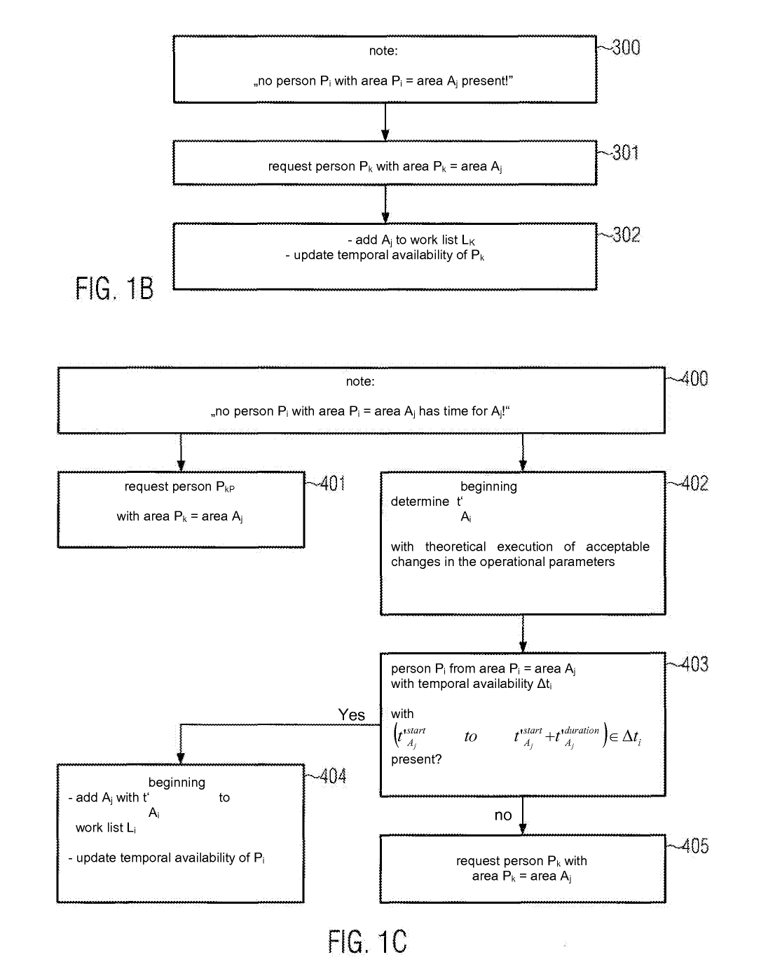

Since in an industrial plant, e.g. in a filling installation, different numbers of persons are available for the execution of necessary jobs at different times and since these, in addition, can be active in different task areas, such as operation, maintenance and/or quality control, corresponding personal details are needed for the establishment of an individual work list for each person. The personal details 100 may, as shown in FIG. 1, comprise information on the work area(s) area Pᵢ in which the person Pᵢ is working, and details on the person's working time (beginning t_{P}_{ᵢ}^{work,start}, end t_{P}_{ᵢ}^{work,end}) and on breaks (beginning t_{P}_{ᵢ}^{break,start}, end t_{P}_{ᵢ}^{break,end}). Instead of the indication of break times, it is also possible to indicate several working time areas which leave out the break times. The index i extends over a value range of i=1 to i=n, where n corresponds to the maximum number of persons found in the personal data.

Moreover, one needs information on the tasks to be executed which are to be distributed into the work lists of the persons Pᵢ. The details regarding the task data 101 may contain information on the task area area Aⱼ (operation, maintenance, quality control) in which a task Aⱼ is to be performed, and information at which place, i.e. in which component of the installation (e.g. labeling machine, filler, packer), the task is performed, information about the temporal start t_{A}_{ⱼ}^{start} at which the task is to start, and its duration t_{A}_{ⱼ}^{duration}. The indicated duration t_{A}_{ⱼ}^{duration} may be a value which was averaged from the corresponding tasks Aⱼ previously performed and is now used as a reference value. The index j extends over a value range of j=1 to j=m, where m corresponds to the maximum number of tasks which are present in the task data.

Now, in order to establish the individual work lists Lᵢ for the individual persons Pᵢ, a correlation must be established by means of an establishment process 102 between the personal data 100 and the task data 101. The correlation follows from the consideration of the temporal availability of the persons and the time details for a task and from the consideration of areas in which a person is allowed to work and the area in which a task is to be performed.

Moreover, an adaptation of operational parameters of the installation may be required for avoiding a system standstill and, nevertheless, for performing the required tasks Aⱼ when it becomes apparent during the preparation of the work lists Lᵢ 104 that, otherwise, an assignment of tasks Aⱼ is not possible, for instance for the reason that the temporal beginning of a task Aⱼ may experience a temporal shift of the beginning of the task by adaptation of operational parameters, and the task can thereby be distributed.

To be able to carry out an adaptation of operational parameters and thus an adaptation of the temporal start t_{A}_{ⱼ}^{start} of a task Aⱼ, the operational parameters of the industrial plant and acceptable changes in operational parameters are indicated as boundary conditions 103, for instance a value range in which the speed of a transport belt can be changed and/or a value range in which the label run per minute can be changed. These acceptable changes in operational parameters further permit an orderly installation operation and also make it possible that possibly forthcoming tasks Aⱼ which could otherwise not be performed temporally can after all be performed by changing the temporal start t_{A}_{ⱼ}^{start} of the task Aⱼ. If such a task Aⱼ could not be performed, this might have the consequence that an unplanned system stillstand would be required.

The establishment process for the work lists Lᵢ 104 for the individual persons Pᵢ shall be explained in more detail with reference to FIGS. 1A to 1C.

FIG. 1A shows that it is first determined in step 200 for a first task Aj with j=1 and for a first person Pᵢ with i=1 whether the task area area Aⱼ corresponds to the work area area Pᵢ. When it is determined that task area and work area do not conform to each other, it is first checked in step 201 whether a further person Pᵢ is present for whom the determination can be carried out. If there is no further person present (i=n), the process will end in step 202.

Optionally in 203, as shown in FIG. 1B, it may be indicated in step 300 that no person Pi is present whose work area coincides with the task area of the task Aⱼ. In a further step 301, a new person Pₖ may be requested whose work area coincides with the task area. In step 302, the task Aⱼ can then be added to a work list Lₖ of the new person Pₖ. Moreover, in step 302 a temporal availability of the new person Pₖ can be updated in the personal data of the new person Pₖ, so that no further task can be assigned to the new person Pₖ for a period defined by the temporal beginning and the temporal duration of the task Aⱼ.

When it is determined in FIG. 1A in step 200 that task area area Aⱼ and work area area Pᵢ do not coincide and when the determination whether a further person Pᵢ is present for whom the determination can be carried out reveals that a further person is present (i.e. i is not equal to n), the determination whether the task area area Aⱼ coincides with the work area is thereafter carried out in 204 for the next person with i=i+1; it is thus determined whether area Aⱼ=area Pᵢ₊₁.

When the determination reveals in step 200 that task area area Aⱼ and work area area Pᵢ coincide, it is checked in step 205 on the one hand whether the temporal beginning and a temporal end (i.e. the temporal beginning plus the temporal duration) of the task Aⱼ are in an area for which person Pᵢ works, i.e. whether the following is applicable

t_{P}_{ᵢ}^{work,start}<t_{A}_{ⱼ}^{start},t_{A}_{ⱼ}^{start}+t_{A}_{ⱼ}^{duration}<t_{P}_{ᵢ}^{work,end} (1).

On the other hand, it is checked in step 205 whether the temporal beginning and the temporal end of the task Aⱼ are not within an area in which the person Pᵢ has a break, i.e. it is checked whether the following is applicable:

(t_{A}_{ⱼ}^{start} to t_{A}_{ⱼ}^{start}+t_{A}_{ⱼ}^{duration})∉(t_{P}_{ᵢ}^{break,start} to t_{P}_{ᵢ}^{break,end}) (2).

If both conditions (1) and (2) are satisfied, the task Aⱼ can be added in a next step 206 to a work list of person Pᵢ the task Aⱼ can be removed from the task data, and the temporal availability of person Pᵢ can be updated in the personal data of the person Pᵢ.

It is determined in a further step 207 whether all tasks Aⱼ have been distributed, i.e., it is checked whether j=m. If this is the case, the process will end in step 208. If this is not the case, i.e. there are further tasks Aⱼ that are to be distributed, the determination whether the task area coincides with the work area area P, is carried out in the subsequent step 209 for the next task Aⱼ with j=j+1; it is thus determined whether area Aⱼ₊₁=area Pᵢ.

If the two conditions (1) and (2) are not satisfied, it is checked in a further step 210 whether there is a further person Pᵢ for whom the determination can be carried out. If there is no further person any more (i=n), the process will end in step 211.

Optionally, in 212, as shown in FIG. 1C, it may be indicated in step 400 that no person Pᵢ with a work area area Pᵢ, which coincides with the task area area Aⱼ, has time for the task Aⱼ.

In step 401 one can then request a new person Pₖ who is working in a work area area Pₖ coinciding with the task area area Aⱼ of the task.

Or it may be provided in step 402 that a temporal beginning t′_{A}_{ⱼ}^{start} is calculated for the task Aⱼ, which is obtained when a change in operational parameters of the installation is made. Defined specifications may here be available as to which extent an operational parameter is permitted to be changed (“acceptable change”, “predefined, permitted changes”).

If a new temporal beginning t′_{A}_{ⱼ}^{start} of the task Aⱼ has been determined, one can check in step 403 whether there is a person Pᵢ with a work area area Pᵢ, which coincides with the task area area Aⱼ, who is temporally available:

(t′_{A}_{ⱼ}^{start} to t′_{A}_{ⱼ}^{start}+t_{A}_{ⱼ}^{duration})∈Δtᵢ (3),

where Δtᵢ corresponds to a period during which the person Pᵢ is available, i.e. in this period there are no breaks or other tasks to be performed.

If there is a corresponding person Pᵢ, one can add in step 404 the Aⱼ with the new temporal beginning t′_{A}_{ⱼ}^{start} to a work list Lᵢ of the person Pᵢ. Moreover, the temporal availability of the person Pᵢ can be updated in the personal data of the person Pᵢ, so that no further task can be assigned to the person Pᵢ for a period which is defined by the temporal beginning t′_{A}_{ⱼ}^{start} and the temporal duration t_{A}_{ⱼ}^{duration} of the task Aⱼ.

In the absence of a corresponding person Pᵢ a new person Pₖ can be requested in step 405, whose work area area Pₖ coincides with the task area area Aⱼ. The task Aⱼ can then be added with the new temporal beginning t′_{A}_{ⱼ}^{start} to a work list Lₖ of the new person Pₖ. Moreover, a temporal availability of the new person Pₖ can be updated in the personal data of the new person Pₖ, so that no further task can be assigned to the new person Pₖ for a period defined by the temporal beginning t′_{A}_{ⱼ}^{start} and the temporal duration t_{A}_{ⱼ}^{duration} of the task Aⱼ.

When the determination in FIG. 1A reveals in step 205 that one or both of the conditions (1) and (2) are not satisfied, and when the determination reveals in step 210 that there is a further person (i.e. i is not equal to n), the determination whether the task area area Aj coincides with the work area is carried out in the following in 213 for the next person with i=i+1; hence, it is determined whether area Aⱼ=area Pᵢ₊₁.

Hence, in the individual process steps all tasks are performed in successive order, so that they can be distributed to work lists of persons.

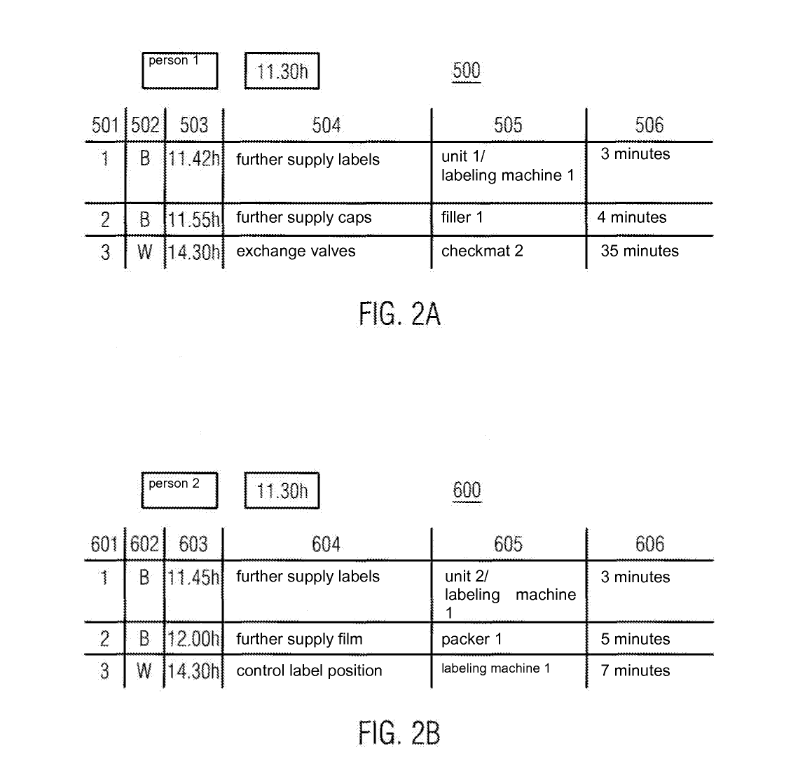

FIGS. 2A and 2B show two exemplary work lists 500, 600 at a current time 11:30 h for a first person and for a second person; the persons may be the staff of an industrial plant. The work lists 500, 600 contain information on the work area (second column) 502, 603, the temporal beginning of the job to be performed (third column) 503, 603, the task to be performed (fourth column) 504, 604, the place (fifth column) 505, 605 where the task is to be performed, and a planned duration (sixth column) 506, 606 for performing the task. The first column 501, 601 serves to number the various tasks consecutively.

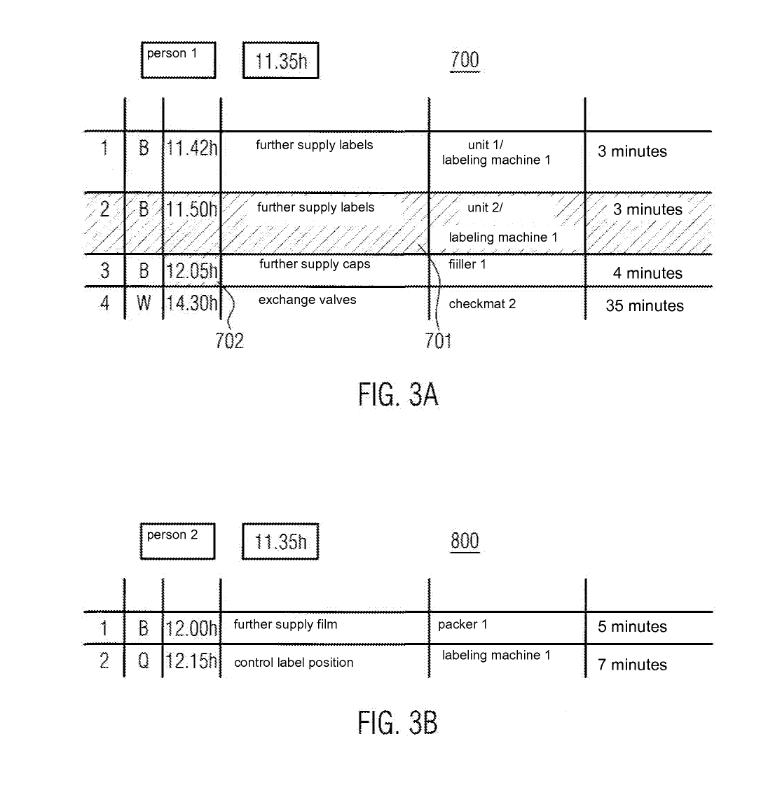

FIGS. 3A and 3B show the work lists 700, 800 of the first and the second person at another current time 11:35 h. The second person is not available for the execution of work, starting from 11:35 h for a period of probably 15 minutes, so that the person's work within this timeframe must be redistributed. For instance the task “further supply labels”; unit 2/labeling machine at 11:45 h″ cannot be executed by the second person and this work from the task area “operation” is passed on to the first person who is also in charge of the task area “operation”. The first person, however, must further supply labels at the unit 1/labeling machine 1 already at 11:42 h so that the planned time of 11:45 h of the second person's task to be taken over does not match with the already existing work plan of the first person. However, if there is for instance no further person available who is working in the task area “operation”, one must find a way that the first person can nevertheless perform the task of the second person.

In the process of updating the work lists one can therefore check in case of time collisions whether a further person is available in the task area where there is no time collision with already existing tasks. If this is the case the task of the second person can be handed over to that person. If this is not the case, one can check in the process of updating the work lists whether a temporal shift of the task to be added or of tasks already existing in the work list is possible. Such a temporal shift can e.g. be made possible by adapting operational parameters of the industrial plant accordingly.

One can determine by way of the process that the labels can be further supplied at unit 2/labeling machine 1 also at 11:50 h instead of 11:45 h, if the industrial plant is operated with reduced label consumption, i.e. for instance the amount of the bottles to be labeled is decreased by reducing the throughput. Hence, the operational parameters of the industrial plant must just be adapted, but there is no undesired system standstill caused by consumed labels.

The further supply of the caps at 11:55 h can also be postponed to a later time of 12:05 h by adapting the operational parameters of the system, so that it is possible to give the first person enough time to walk from the labeling machine 1 to the filler 1.

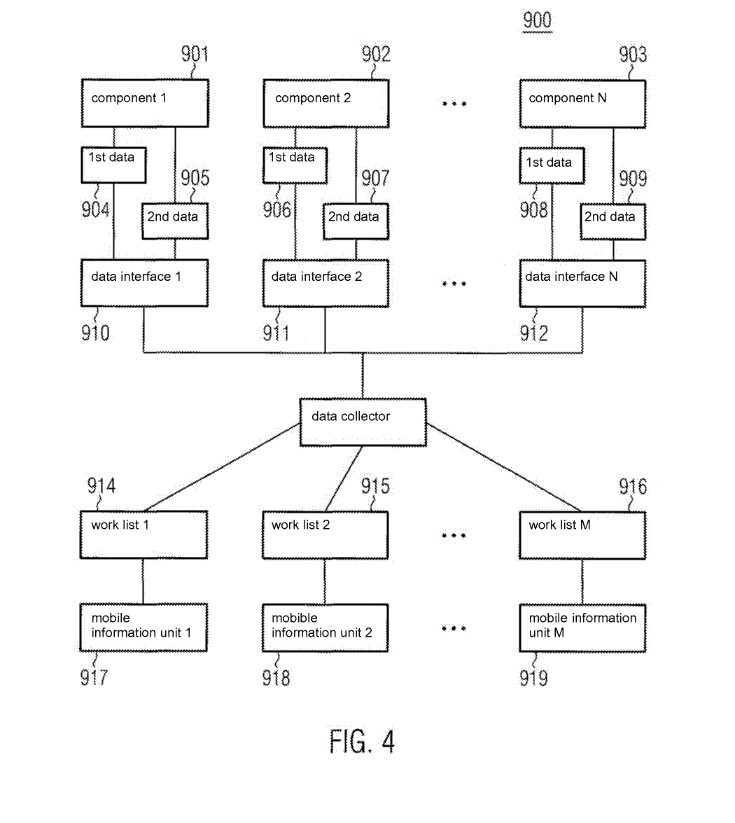

To indicate the changes/updates in his work plan to the first person, new tasks or new times can be highlighted or marked in another way. In FIG. 4, this is shown in an exemplary manner by way of a shade 701 of the second line (second person's task taken over) and a shade 702 of the third field in the third line (new time) in the work list of the first person. Such a highlighting can be deactivated by the first person by pressing a key, e.g. after having taking note thereof, so that the representation can be made in the same way for all tasks. However, there may also be an automatic deactivation after a predefined interval after the updating process.

Apart from an automatic change in task times, a person who is to take over a task from another person can also indicate a changed time independently. In response to the changed time operational parameters of the installation are adapted, so that there will be no undesired system standstill.

FIG. 4 shows a filling installation 900 comprising a plurality of components 901, 902, 903, wherein each of the components 901, 902, 903 generates first data 904, 906, 908 regarding a planned operation of the filling installation 900, and second data 905, 907, 909 regarding malfunctioning of the filling installation 900. At a data interface 910, 911, 912 of a component 901, 902, 903 the data 904-909 are made available and can be transmitted to a data collector 913. The data interfaces 910, 911, 912 can also receive one or several queries of the data collector 913 and transmit, in response thereto, the first data 904, 906, 908 and the second data 905, 907, 909 to the data collector 913.

The data collector 913 draws up current and individual work lists 914, 915, 916 based on the first 904, 906, 908 and the second data 905, 907, 909 and transmits each of the work lists 914, 915, 916 to a corresponding mobile information unit 917, 918, 919. A mobile information unit 917, 918, 919 receives the work list 914, 915, 916 and represents said list, so that a user of the mobile information unit 917, 918, 919 can inspect the work list 914, 915, 916.

The mobile information unit 917, 918, 919 can be designed such that third data can be transmitted to the data collector. The user of the mobile information unit 917, 918, 919 can e.g. make an entry that he is not available for a task and/or malfunction in the work list 914, 915, 916 which is represented on the mobile information unit 917, 918, 919. This information can be transmitted to the data collector 913, so that this task and/or malfunction is incorporated into another work list, whereby the task can for instance be performed and/or the malfunction eliminated by another user.

1. A filling installation, comprising:
at least one component, and for each component first data relating to a planned operation of the filling installation are available, and each component generates second data relating to malfunctioning of the filling installation, and each component is designed to make available the first and second data at a data interface of the component, the data interface being designed to transmit the first and the second data to a data collector of the filling installation and/or to receive queries of the data collector and, in response to a query, to transmit the first and the second data to the data collector,
the data collector configured to receive and/or to query the first and the second data of the at least one component, and the data collector further configured to establish at least one current and individual work list based on the first and on the second data and to transmit it to a mobile information unit, and
at least one mobile information unit, and each mobile information unit is designed to receive and represent one of the at least one work list.

2. The filling installation according to claim 1, and the data collector further designed to receive and/or to query personal data.

3. The filling installation according to claim 1, and the at least one component is further designed to prepare the first and the second data.

4. The filling installation according to claim 1, and the at least one mobile information unit is further designed to transmit third data to the data collector.

5. A computer-implemented method for the automatic establishment of a current and individual work list with at least one task to be performed for a person, with the work list being transmitted to a mobile information unit and intended for use in an industrial plant by the person, the method comprising:
reading in personal data of at least one person, with the personal data for each of the at least one person comprising data relating to at least one work area;
reading in task data from a first data set and from a second data set, with the task data of at least one task are read in, and the task data for each of the at least one task comprise data relating to a task area;
a) determining for a first of the at least one task whether the task area of the first task corresponds to the at least one work area of a first of the at least one person;
if yes: b) determining whether a temporal start and a temporal duration of the first task are within a range between a temporal beginning and a temporal end of a working time of the first person;
if yes: c) adding the first task to a first work list of the first person;
d) removing the first task from the task data;
e) updating a temporal availability of the first person in the personal data of the first person, so that no further task can be assigned to the first person for a period defined by the temporal beginning and the temporal duration of the first task;
f) if at least one other task is present in the task data, returning to step a), wherein it is determined whether for another one of the at least one task the task area of the other task corresponds to the at least one work area of the first of the at least one person;
if no: g) returning to step a), wherein it is determined whether the task area of the first task corresponds to the at least one task area of another one of the at least one person and performing the following steps for the other person;
if no: h) returning to step a), where it is determined whether the task area of the first task corresponds to the at least one work area of another one of the at least one person and performing the following steps for the other person.

6. The computer-implemented method according to claim 5, and instead of step h), if no other person is present, the method comprises:
requesting a new person whose at least one work area corresponds to the first task area;
adding the first task to a work list of the new person;
removing the first task from the task data; and
updating a temporal availability of the new person in the personal data of the new person, so that no further task can be assigned to the new person for a period defined by the temporal beginning and the temporal duration of the first task.

7. The computer-implemented method according to claim 5, and instead of step g), if no other person is present, further comprising:
requesting a new person whose at least one work area corresponds to the first task area;
adding the first task to a work list of the new person;
removing the first task from the task data; and
updating a temporal availability of the new person in the personal data of the new person, so that no further task can be assigned to the new person for a period defined by the temporal beginning and the temporal duration of the first task.

8. The computer-implemented method according to claim 5, and further comprising:
reading in boundary conditions, the boundary conditions comprising operational parameters of an industrial plant and predefined, permitted changes in the operational parameters.

9. The computer-implemented method according to claim 8, the method further comprises:
determining a new start time of the task based on the predefined, permitted changes in the operational parameters;
determining whether for the new start time of the task the task area corresponds to the at least one work area of one of the at least one person and whether said person is temporally available, by determining whether the new start time and the temporal duration of the task are within a range between a temporal beginning and a temporal end of a working time of the person;
if yes:
adding the task to a work list of the person;
removing the task from the task data;
updating a temporal availability of the person in the personal data of the person;
if no:
requesting a new person whose at least one work area corresponds to the task area if the read-in personal data of at least one person comprise no person having time for the task;
adding the task to a work list of the new person;
removing the task from the task data;
updating a temporal availability of the new person in the personal data of the new person, so that no further task can be assigned to the new person for a period defined by the temporal beginning and the temporal duration of the first task.

10. The computer-implemented method according to claim 5, and further comprising:
transmitting the work list of the at least one person to a mobile information unit of the at least one person.

11. The computer-implemented method according to claim 10, and further comprising:
representing the work list of the at least one person by means of a representation device of the mobile information unit of the at least one person.

12. The computer-implemented method according to claim 10, and further comprising:
graphically representing a route the at least one person is to take in order to arrive at a place at which a task is to be performed, the graphic representation being performed by means of the representation device of the mobile information unit.

13. The computer-implemented method according to claim 10, and further comprising:
graphically representing a current location of the at least one person and graphically representing a/the place where a task is to be performed, the graphic representation being performed by means of the representation device of the mobile information unit.

14. The computer-implemented method according to claim 11, and the graphic representation being in a two-dimensional and/or three-dimensional way.

15. The computer-implemented method according to claim 5, and further comprising:
reading-in new personal data of at least one person, the new personal data for each of the at least one person comprising data relating to at least one work area.

16. The computer-implemented method according to claim 5, and further comprising:
reading-in new task data of at least one task, the new task data for each of the at least one task comprise data relating to a task area.

17. The computer-implemented method according to claim 5, and the at least one work area comprises one of operation, quality control and/or maintenance, and temporal beginning and temporal end of working times.

18. The computer-implemented method according to claim 5, and the task area comprises one of operation, quality control, maintenance, malfunction, and temporal beginning and temporal duration of the at least one task.

19. The computer-implemented method according to claim 15, and the at least one work area comprises one of operation, quality control, maintenance, malfunction, and temporal beginning and temporal end of working times.

20. The computer-implemented method according to claim 16, and the at least one task area comprising operation, quality control, maintenance, malfunctions, and temporal start and temporal duration of the at least one task.
